(19) United States
(12) Patent Application Publication
(10) Pub. No.: US 2006/0105285 A1
(43) Pub. Date: May 18, 2006

(54) Nonelastomeric dental article with a protective fluoropolymer layer

(76) Inventors: Naiyong Jing, Woodbury, MN (US); Gerald Rainer Adalbert Hofmann, Oakdale, MN (US); Tsi-Zong Tzou, Arcadia, CA (US)

Correspondence Address: 3M INNOVATIVE PROPERTIES COMPANY, PO BOX 33427, ST. PAUL, MN, 55133-3427, US

(21) Appl. No.: 10/991,234

(22) Filed: Nov. 17, 2004

(51) Int. Cl. A61C 3/00

(52) U.S. Cl. 433/8; 433/20

(57) ABSTRACT

Protective fluoropolymer layers for dental articles, particularly orthodontic appliances, are provided that reduce adhesion of materials such as food, bacteria, and proteinaceous substances to these surfaces, which can cause staining. Methods of reducing adhesion of these materials to such surfaces are also provided.

### BACKGROUND

Materials used in the oral environment, such as orthodontic appliances, are susceptible to discoloration. Such discoloration, i.e., staining, can result from dietary chromagens and/or the formation of plaque.

Coatings have been used to reduce such staining on hard tissues or surfaces of the oral environment, including dental articles; however, the challenge in stain-resistant coatings is that the material has to adhere to the substrate and not crack or flake off. An additional challenge is that the coating has to be durable enough to withstand toothbrushing.

Known coating compositions and methods include coating with a fluorine-containing copolymer. For example, U.S. Pat. No. 5,662,887 (Rozzi et al.) discloses coating orthodontic appliances with a copolymer having repeating units of A, B, and C where monomer A is 1-80 wt-% of a polar or polarized group (e.g., acrylic acid), B is 0-98 wt-% of a modulating group (e.g., isobutyl methacrylate and methyl methacrylate), and C is 1-40 wt-% of hydrophobic fluorine-containing groups. Coatings containing a polysiloxane-containing copolymer are also known, as disclosed in U.S. Pat. No. 5,876,208 (Mitra et al.).

There is still a need for stain-resistant coatings for dental articles containing nonelastomeric substrates.

The discussion of prior publications and other prior knowledge does not constitute an admission that such material was published, known or part of the common general knowledge.

### SUMMARY

The present invention provides dental articles, particularly orthodontic appliances (e.g., brackets, buccal tubes, archwires, sheaths, retainers, arch expanders, class II and class III correctors, face bows, and buttons), that include a nonelastomeric substrate and a protective fluoropolymer-containing layer thereon. Such protective layers reduce adhesion of materials such as dietary chromagens, bacteria, and proteinaceous substances, for example, to these surfaces, which can cause staining. Methods of reducing adhesion of these materials to such surfaces are also provided.

In the one embodiment, the present invention provides a dental article that includes a nonelastomeric substrate having disposed thereon at least one layer that includes a fluoropolymer, wherein the fluoropolymer is a partially fluorinated copolymer, and further wherein: the fluoropolymer includes at least 40 wt-% fluorine; and at least 50% of all fluorine atoms present within the fluoropolymer are within the backbone of the fluoropolymer.

Suitable fluoropolymers can be homopolymers or copolymers (i.e., polymers prepared from two or more different monomers, which includes terpolymers, tetrapolymers, etc.). Preferably, the fluoropolymer is a copolymer.

The fluoropolymers can be fluoroplastics) or fluoroelastomers. Herein, a fluoroplastic is a fluorinated polymer that has a degree of structural rigidity. In contrast, a fluoroelastomer is an amorphous fluorinated polymer that has no well-defined melting point. Typically, a fluoroelastomer is a polymer having properties similar to those of vulcanized natural rubber, namely the ability to be stretched to at least twice their original length and to retract very rapidly to approximately their original length when released.

Examples of suitable fluoropolymers include tetrafluoroethylene/hexafluoropropylene/vinylidene fluoride terpolymers (THV), polyvinylidene fluoride, vinylidene fluoride/hexafluoropropylene copolymers, vinylidene fluoride/tetrafluoroethylene copolymer, and mixtures thereof.

In the one embodiment, the present invention provides a dental article that includes a nonelastomeric substrate having disposed thereon at least one layer that includes a perfluoroelastomer. Examples of suitable perfluoroelastomers (i.e., perfluorinated elastomeric polymers) include perfluorinated rubbers of the polymethylene type having all fluoro, perfluoroalkyl, or perfluoroalkoxy substituent groups on the polymer chain; a small fraction of these groups may contain functionality to facilitate vulcanization. A preferred example includes a copolymer of tetrafluoroethylene and perfluoromethyl vinyl ether.

The fluoropolymer-containing layer can include a mixture (e.g., blend) of fluoropolymers or a mixture of one or more fluoropolymers with one or more nonfluorinated polymers. The nonfluorinated polymer can be of a wide variety, and is preferably selected from the group consisting of acrylic polymers (e.g., polymethyl methacrylate (PMMA)), urethane polymers, vinyl acetate copolymers, and combinations thereof.

In certain embodiments, the present invention also provides methods of reducing adhesion of materials such as food stains, bacteria and proteinaceous substances to a dental article.

In one embodiment, the method includes: providing a dental article including a nonelastomeric substrate; and depositing at least one layer comprising a fluoropolymer to at least a portion of the nonelastomeric substrate. In this embodiment, the fluoropolymer is a partially fluorinated copolymer, includes at least 40 wt-% fluorine, and at least 50% of all fluorine atoms present within the fluoropolymer are within the backbone of the fluoropolymer.

In one embodiment, the method includes: providing a dental article including a nonelastomeric substrate; and depositing at least one layer comprising a perfluoroelastomer to at least a portion of the nonelastomeric substrate.

In yet another embodiment, the present invention provides a nonelastomeric substrate (which may or may not be in the form of, or form a part of, a dental article) including an organic polymeric material (e.g., PET) having disposed thereon at least one layer comprising a fluoropolymer, wherein the fluoropolymer is prepared from a halogen-containing fluoropolymer and a peroxide curing system (e.g., including an organic peroxide initiator and a multifunctional aliphatic unsaturated compound).

The terms “comprises” and variations thereof do not have a limiting meaning where these terms appear in the description and claims.

The terms “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### DETAILED DESCRIPTION OF ILLUSTRATIVE EMBODIMENTS

Dental articles, particularly orthodontic appliances, which include a nonelastomeric substrate, can be very difficult to coat with a protective material. The present invention provides a fluorine-containing polymeric material that adheres well to nonelastomeric materials that form a part of a dental material, particularly an orthodontic device. In other words, the polymeric materials provided in accordance with the invention are highly substantive to nonelastomeric surfaces. The protective materials have high resistance to food stains, plaque, bacteria, and the like, as compared to dental materials that do not contain the protective fluoropolymeric material thereon.

The fluoropolymers are provided in an amount sufficient to provide resistance of the underlying surface to bacterial adhesion, plaque formation, or staining from foods or dyes. The fluoropolymer may be provided as a continuous or semi-continuous layer. Preferably, the fluoropolymer is applied in an amount at least sufficient to provide a substantially continuous monolayer of polymer as described herein on the underlying surface. The protective coating may be in the form of one or more layers, which may be of the same or different fluoropolymers.

Other advantages may also be realized through the use of the fluoropolymer materials of the present invention. In particular, a stain-resistant fluoropolymer used on orthodontic appliances such as brackets and wires may result in reduced friction and accelerated tooth movement. Another benefit may be reduced biofilm formation on orthodontic appliances and hence less enamel decalcification, since the fluoropolymer layer with a low surface energy that repels stains is likely to inhibit the attachment of bacteria. Yet another benefit may be that the inert low energy surface protects the nonelastomeric material from biodegradation.

Dental articles that include a nonelastomeric material can be protected with a fluoropolymer as discussed herein. Such articles include orthodontic appliances (e.g., brackets, buccal tubes, archwires, sheaths, retainers, arch expanders, class II and class III correctors, face bows and buttons), bridges, crowns, dentures, retainers, tooth positioners, dental impression trays, relatively inflexible tooth alignment trays, and mouthguards. Preferred dental articles of the present invention include orthodontic appliances, particularly brackets and wires.

In addition to, or as an alternative to, applying the fluoropolymer on external surfaces of an orthodontic appliance, the fluoropolymer may be applied to inner wall surfaces of the appliance that define a passage for receiving an archwire. For example, the fluoropolymer may be applied to the lingual, occlusal, and/or gingival surfaces of an archwire slot of an orthodontic bracket, or to the inner tubular surface of an archwire passage of a buccal tube or sheath.

Nonelastomeric dental articles typically include metals, ceramics, and relatively inflexible organic polymeric materials. Examples of suitable metals include stainless steel alloys (such as Series 300, Series 400 and 17-PH), titanium alloys (such as described in U.S. Pat. No. 5,947,723 (Mottate et al.) and U.S. Pat. No. 5,232,361 (Sachdeva et al.)), beta-titanium alloys (such as described in U.S. Pat. No. 4,197,643 (Burstone et al.) and PCT Published Application No. WO 99/45161), iron-based alloys with precipitates of titanium (such as described in U.S. Pat. No. 6,280,185 (Palmer et al.) cobalt chromium alloys such as Elgiloy brand alloy, shape-memory alloys such as nickel-titanium and ternary-substitution nickel-titanium alloys, and titanium alloys such as beta-titaniums. Examples of suitable ceramic materials include monocrystalline alumina (such as described in U.S. Pat. No. 4,639,218 (Jones et al.) and polycrystalline alumina (such as described in U.S. Pat. No. 4,954,080 (Kelly et al.) and U.S. Pat. No. 6,648,638 (Castro et al.).

Examples of suitable organic polymeric materials include thermoset and thermoplastic materials. When the dental article is an orthodontic appliance, the polymeric material preferably has sufficient strength to resist undue creep, deformation, or fracture. Suitable thermoset resins include epoxies, acrylics, polyesters, polyurethanes, and mixtures thereof. Suitable thermoplastic resins include acrylics, polysulfones, polycarbonates (such as LEXAN brand polycarbonate, GE), polyesters (such as polyethylene terephthalate (PET)), and polyurethanes. Optionally, the polymeric materials can be reinforced with fibers (such as described in U.S. Pat. No. 4,717,341 (Goldberg et al.) and U.S. Pat. No. 5,318,440 (Adam et al.) or with a framework (such as described in U.S. Pat. No. 3,930,311 (Andrews) and U.S. Pat. No. 5,597,302 (Pospisil et al.).

Typically, current nonelastomeric dental articles, particularly orthodontic brackets and wires, find particular advantage when coated with a fluoropolymer as discussed herein. Many fluoropolymers have been largely unexplored as fluoropolymer coatings on dental articles, particularly those made of organic substrates. This is due in part to the fact that: (a) polytetrafluoroethylene (PTFE) and related fluoropolymers have no solubility in common organic solvents; (b) they have a reputation of being nonadherent to other substrates (thus providing poor durability and mechanical properties of the coatings); and (c) most fluoroelastomers require curing after application using curing chemistries that may shorten the shelf life of a coating composition in solution form and may not be suitable for use in medical applications due to toxicology concerns.

For certain embodiments, suitable fluoropolymers are partially fluorinated polymers (i.e., such polymers are not perfluorinated). Preferably, such partially fluorinated fluoropolymers include at least 40 wt-% fluorine, more preferably at least 50 wt-% fluorine atoms, and even more preferably at least 60 wt-%. Such partially fluorinated polymers can be fluoroelastomers or fluoroplastics.

In certain embodiments, the fluoropolymer is perfluorinated. In such embodiments, the perfluorinated polymers are perfluoroelastomeric polymers.

In certain embodiments, preferably, at least 50% of the fluorine atoms present in the polymer are in the backbone of the polymer. More preferably, at least 75% of the fluorine atoms present in the polymer are in the backbone of the polymer, and even more preferably, substantially all the fluorine atoms are in the backbone of the polymer. As used herein, the longest continuous chain in a molecule represents the backbone. Groups attached to the backbone are called substituents or side chains.

Suitable fluoropolymers are those having a molecular weight of at least 10,000.

Examples of suitable fluoropolymers are those derived from at least one monomer selected from the group consisting of vinylidine fluoride, vinyl fluoride, and combinations thereof. These can be homopolymers (e.g., poly(vinylidene fluoride)) or copolymers (e.g., vinylidine fluoride/tetrafluoroethylene copolymer and vinylidine fluoride/hexafluoropropylene copolymer). Other monomers, particularly ethylenically unsaturated monomers, which may or may not be fluorinated (such as, ethylene or chlorotrifluoroethylene monomers), can be used in combination with these monomers as long as the polymer is derived from at least one of the listed monomers. Preferably, the fluoropolymer includes interpolymerized units derived from vinylidene fluoride, vinyl fluoride, and combinations thereof.

Examples of suitable fluoropolymers include tetrafluoroethylene/hexafluoropropylene/vinylidene fluoride terpolymers (THV), polyvinylidene fluoride, vinylidene fluoride/hexafluoropropylene copolymers, vinylidene fluoride/tetrafluoroethylene copolymer, and mixtures thereof.

The fluoropolymers may or may not be melt-processable (e.g., thermoplastic). Melt-processable polymers include, for example, a terpolymer of tetrafluoroethylene, hexafluoropropylene, and vinylidene fluoride (THV). Non-melt processable polymers include, for example, certain fluoroelastomers.

Preferred fluoropolymer materials useful in the present invention include copolymers (including terpolymers, etc.) with interpolymerized units derived from vinylidene fluoride (sometimes referred to as “VF₂” or “VDF”). Preferably fluoropolymer materials of this preferred class include at least 3 percent by weight (wt-%) of interpolymerized units derived from VF₂. Such polymers may be homopolymers of VF₂ or copolymers (including terpolymers) of VF₂ and other ethylenically unsaturated monomers. A particularly preferred such polymer includes interpolymerized units derived from vinylidene fluoride and hexafluoropropylene.

VF₂-containing homopolymers and copolymers can be made by well-known conventional means, for example by free-radical polymerization of VF₂ with or without other ethylenically unsaturated monomers. The preparation of colloidal aqueous dispersions of such polymers and copolymers is described, for example, in U.S. Pat. No. 4,335,238 (Moore et al.). Other methods of preparing VF₂-containing fluoropolymer using emulsion polymerization techniques are described in U.S. Pat. No. 4,338,237 (Sulzbach et al.) or U.S. Pat. No. 5,285,002 (Grootaert).

Other fluorinated polymers useful in the practice of the invention include homopolymers and copolymers (including terpolymers, etc.) that include interpolymerized units derived from perfluoromethyl vinyl ether (“PMVE”).

Useful fluorine-containing monomers for preparing VF₂-containing polymers include hexafluoropropylene (“HFP”), tetrafluoroethylene (“TFE”), chlorotrifluoroethylene (“CTFE”), 2-chloropentafluoro-propene, perfluoroalkyl vinyl ethers (e.g., CF₃OCF═CF₂ or CF₃CF₂OCF═CF₂), 1-hydropentafluoropropene, 2-hydro-pentafluoropropene, dichlorodifluoroethylene, trifluoroethylene, 1,1-dichlorofluoroethylene, vinyl fluoride, and perfluoro-1,3-dioxoles, such as those described in U.S. Pat. No. 4,558,141 (Squire). Certain fluorine-containing di-olefins also are useful, such as perfluorodiallylether and perfluoro-1,3-butadiene.

Fluorine-containing monomers also may be copolymerized with fluorine-free (preferably terminally unsaturated) olefinic comonomers, e.g., ethylene or propylene. Preferably at least 50% by weight of all monomers in a polymerizable mixture are fluorine-containing. Useful olefinically unsaturated monomers include alkylene monomers such as ethylene and propylene. Such monomers can contribute to mechanical properties or low temperature performance.

Fluorine-containing monomers may also be copolymerized with iodine-, chlorine-, cyano-, or bromine-containing cure-site monomers (particularly halogen-containing cure-site monomers) in order to prepare peroxide curable polymers. Suitable cure-site monomers include terminally unsaturated monoolefins of 2 to 4 carbon atoms such as bromodifluoroethylene, bromotrifluoroethylene, iodotrifluoroethylene, and 4-bromo-3,3,4,4-tetrafluorobutene-1,4-cyanoperfluorobutyl vinyl ether (CF₂═CFOCF₂CF₂CF₂CF₂CN). An example of a halogen-containing fluoropolymer E-15742 is a terpolymer of TFE/HFP/VDF with brominated cure site monomer. Such halogen-containing fluoropolymers can be cured with a peroxide curing system.

Suitable materials are also commercially available. These include, for example, those commercially available under the trade designations THV (terpolymers of CF₂═CF₂/CH₂═CF₂/CF₃CF═CF₂ (TFE/VDF/HFP) fluoroelastomer available from Dyneon LLC of Saint Paul, Minn.), KYNAR (VDF homopolymers and VDF copolymers available from Atofina), FLUOREL (e.g., a copolymer of CF₂═CH₂/CF₃CF═CF₂ (VDF/HFP) fluoroelastomer available from Dyneon LLC), and fluoroelstomers (copylymers of VF₂/HFP, VF₂/HFP/TFE, TFE/propylene and ethylene/TFE/PMVE) sold under the trade designation VITON/by DuPont.

Other useful fluoropolymers include fluorosilicones and fluoroalkoxyphosphazenes, as long as they have a sufficient amount of fluorine (e.g., at least 40 wt-%) to provide desirable results. Although certain embodiments can include silicon-containing fluoropolymers, others preferably include less than 5 wt-% silicon atoms, more preferably less than 3 wt-% silicon atoms, and even more preferably substantially no silicon atoms.

As mentioned above, in certain embodiments, the fluoropolymer is perfluorinated. In such embodiments, the perfluorinated polymers are perfluoroelastomeric polymers. Examples of such perfluoroelastomeric polymers include copolymers of TFE/PMVE, in which a cure site monomer such as 4-cyanoperfluorobutyl vinyl ether (CF₂═CFOCF₂CF₂CF₂CF₂CN) is generally incorporated for curing purposes.

The above-described fluoropolymers may be mixed (e.g., blended) with one another or with another fluorinated or nonfluorinated polymer to form a composite material useful to construct a fluorinated layer. Polyvinylidene fluoride, for example, may be blended with polymethylmethacrylate (PMMA).

Optionally, the fluoropolymer can be mixed (e.g., blended) with the same material as that of the nonelastomeric substrate, such as ceramics, organic polymeric materials, and metals. Examples of nonfluorinated polymers are those selected from the group consisting of acrylic polymers, urethane polymers, vinyl acetate polymers, and combinations thereof.

When a fluoropolymer is applied to a substrate, it may be applied in the form of the polymer or as precursors to the polymer which are in turn polymerized by thermal, photoinitiated, or redox polymerization.

Fluorinated polymer(s) and optional nonfluorinated polymer(s), or precursors thereof, can be combined with one or more curatives for enhanced curing rates and/or adhesion to the substrate. In particular, halogen-containing fluoropolymers (e.g., a terpolymer of TFE/HFP/VDF with brominated cure site monomer) can be cured with a peroxide curing system. Typically, a peroxide curing system includes an organic peroxide initiator (e.g., benzoyl peroxide, diisopropyl azodicarboxylate, tert-butyl peroxybenzoate, tert-butyl hydroperoxide, LUPERSOL 130 or 110 peroxides from Elf Ato Chem, Crosby, Tex.) and a multifunctional aliphatic unsaturated compound (e.g., triallyl isocyanurate (TAIC), trimethylolpropane trimethacrylate (TMPTMA), divinyl benzene, octadiene). Preferably, a peroxide curing system include, for example, mixtures of triallyl isocyanurate (TAIC) or trimethylolpropane trimethacrylate (TMPTMA) with benzoyl peroxide (BP), and others commercially available from sources such as Aldrich.

A fluoropolymer can be applied onto the substrate by dipping, brushing, or spraying, by over-molding, extruding, or by any other suitable method. The fluoropolymers are preferably coated out of a liquid carrier (e.g., an organic solvent or water).

In dip coating process, the substrate is dipped in a coating liquid, removed, and dried. The coating liquid may be a solution. Suitable organic solvents used in coating compositions include, but are not limited to, methyl ethyl ketone (MEK), acetone, cyclohexanone, dimethyl sulfoxide, dimethylformamide, tetrahydrofuran, n-methylpyrrolidone, dimethylaceteamide, ethyl acetate, fluorinated solvents, and their mixtures.

The concentration of a coating composition should be sufficient to form a coating that is thick enough for stain resistance. The thickness of the protective fluoropolymer layer is preferably at least a monolayer, and sufficiently thin so as not to alter the bulk properties of the nonelastomeric substrate. Preferably, the thickness of a protective fluoropolymer layer is at least 0.01 micron, and more preferably at least 0.5 micron. Preferably, the thickness of a protective layer is no greater than 20 microns, and more preferably, no greater than 2.5 microns.

The desired thickness can be achieved by varying the concentration of the coating composition (solution/dispersion) and the number of passes in the coating process, for example. A typical coating concentration is at least 1 wt-%, although lower concentrations can be used, however, more coating passes may be required. Preferably, the concentration of a coating composition is at least 3 wt-% of the fluoropolymer, based on the total weight of the composition. A typical concentration is no greater than 20 wt-%, although higher concentrations can be used. Preferably, the concentration of a coating composition is no greater than 10 wt-% of the fluoropolymer, based on the total weight of the composition.

The relationship of thickness to concentration is influenced by the viscosity of the coating composition. Polymers having higher molecular weights will give higher viscosity and therefore greater thickness.

Typical coating temperatures and times are sufficient for the coating composition to penetrate the substrate surface, but not so high as to adversely affect the bulk properties of the nonelastomeric substrate. The coating temperature can be room temperature if the solubility of the fluoropolymer is sufficient to give the desired coating composition concentration. The coating composition may be heated to increase the solubility of the fluoropolymer when needed. A preferred coating time is 0.25 second to 10 minutes.

After the coating step, typically, the process includes a thermally curing process. The cure temperature and time are selected to form good bonding without compromising the bulk properties of the nonelastomeric substrate. Typically, such temperatures are at or above the melting temperature of the fluoropolymer but below the softening temperature of the nonelastomeric substrate.

When appropriate, a fluoropolymer can be applied to a nonelastomeric substrate after a cleaning step and/or a priming step. Priming herein refers to coating the substrate with a primer prior to application of the fluoropolymer

A cleaning process typically includes washing the material with a solvent such as ethyl acetate, methyl ethyl ketone, methyl isobutyl ketone, acetone, toluene, and fluorinated solvents.

Primers include, for example, poly-1-lysine, DYNAMAR FC 5155 elastomer additive (3M Dyneon), and polyallylamine. Preferably, the primers include poly-1-lysine and polyallylamine, particularly for THV-containing polymers. A priming process can include, for example, priming with 0.1 weight/volume percent (w/v %) poly-1-lysine/water and optionally baked (e.g., at temperatures of, for example, 90° C., and times of, for example, 15 min).

An alternative method to enhance the adhesion of the fluoropolymer to the substrate is to incorporate an adhesion promoter into the fluoropolymer-containing composition. Examples of such adhesion promoters include multifunctional amines (such as those disclosed in U.S. Pat. No. 5,656,121 (Fukushi)), and aminosilanes (such as those disclosed in U.S. Pat. No. 6,753,087 (Jing et al.)).

The substantivity (i.e., adhesion) of the protective fluoropolymer layers of the present invention may be measured by a number of techniques. For example, one may evaluate whether or not a fluoropolymer layer remains after different assaults, such as toothbushing or soaking in boiling water.

In the toothbrushing test, the force and number of cycles are set to simulate 1 month human brushing. To demonstrate integrity of the fluoropolymer layer after such toothbrushing simulation, the samples can be subjected to a stain test where the fluoropolymer layer protects the sample from staining if the adhesion of the fluoropolymer remains good.

Adhesion can be tested using a boiling water test, in which the samples are soaked in boiling water. If no delamination occurs, the interfacial adhesion is good. Adhesion of preferred coatings of the present invention can survive or remain unchanged even after immersing fluoropolymer-coated samples in boiling water for 3 hours.

Peel strength can be used to quantify the interfacial adhesion. See Example 1 for more description. A desirable peel strength is preferably greater than 0.2 lb/in (0.4 N/cm), more preferably greater than 1 lb/in (1.8 N/cm), and most preferably greater than 4 lb/in (7.0 N/cm).

Stain resistance and low friction of the coatings of the present invention (particularly to foods, beverages, and bacteria) are particularly desirable.

Stain testing can be carried out in a variety of ways. For example, this can involve 24 hour immersion in 100% mustard and other staining agents, or 2 hour immersion in 50:50 mustard/water only.

The samples preferably show less staining in the stain test (preferably, no staining or slight staining) than the control.

### EXAMPLES

The following examples are given to illustrate, but not limit, the scope of this invention. Unless otherwise indicated, all parts and percentages are by weight, and all molecular weights are weight average molecular weight.

Materials

THV 220 is a terpolymer of TFE/HFP/VDF.
KYNAR 7201 is a copolymer of VDF/TFE.
E-15742 is a terpolymer of TFE/HFP/VDF with brominated cure site monomer.
TFE is tetrafluoroethylene.
HFP is hexafluoropropylene.
VDF is vinylidene fluoride.

### Example 1

### Interfacial Adhesion Tests

Polyethylene terephthalate (PET) film was coated with four coating materials. These coating materials included the fluoropolymer materials available under the trade designations THV 220 (3M Dyneon), KYNAR 7201 (Atofina), as well as blends of 8:2 and 9:1 KYNAR 7201 fluoropolymer:polymethyl methacrylate (PMMA M_{w} 120,000 from Aldrich). Coating materials were dissolved in methyl ethyl ketone (MEK). The films were dip coated in 8.5 wt-% solutions. Additionally, ten weight percent solutions of the fluoroelastomer E-15742 (which is available from 3M Dyneon) in MEK were either directly used for coating or combined with a variety of concentrations of curatives (TAIC: triallyl isocyanurate, TMPTMA: trimethylolpropane trimethacrylate, BP: benzoyl peroxide all from Aldrich) described in Tables 1 and 2 for coating. The concentration of the curatives (i.e., curing systems) was based on the percentage in the fluoropolymer, not the final coating composition concentration. After coating, the samples were cured at 140° C. for 10 minutes (min).

To determine the interfacial adhesion between the fluoropolymer and the substrate, two tests were performed. The first test was boiling water immersion. The coated samples were immersed in boiling water for 3 hours. The samples were removed from boiling water and the interface was inspected to determine if the coated fluoropolymer layers were delaminated or not. The results are listed in Table 1.

Peel strength was the second test to determine interfacial adhesion. To facilitate testing of the adhesion between the layers via a T-peel test, a thick film (20 mil (0.51 mm)) of THV 220 or PVDF was laminated onto the side of the films with the fluoropolymer coating in order to gain enough thickness for peel measurement. In some cases, a slight force was applied to the laminated sheet to keep a good surface contact. A strip of TEFLON-coated fiber sheet was inserted about 0.25 inch (0.64 mm) along the short edge of the 2-inch×3-inch (5.08 cm×7.62 cm) laminated sheet between the substrate surface and the fluoropolymer film to provide unbonded region to act as tabs for the peel test. The laminated sheet was then pressed at 200° C. for 2 minutes between heated platens of a Wabash Hydraulic Press (Wabash Metal Products Company, Inc., Hydraulic Division, Wabash, Ind.) and immediately transferred to a cold press. After cooling to room temperature by the cold press, the resulting sample was subjected to T-peel measurement.

Peel strengths of the laminated samples were determined following the test procedures described in ASTM D-1876 entitled “Standard Test Method for Peel Resistance of Adhesives,” more commonly known as the “T-peel” test. Peel data was generated using an INSTRON Model 1125 Tester (available from Instron Corp., Canton, Mass.) equipped with a Sintech Tester 20 (available from MTS Systems Corporation, Eden Prairie, Minn.). The INSTRON tester was operated at a cross-head speed of 4 inches/min (10.2 cm/min). Peel strength was calculated as the average load measured during the peel test and reported in pounds per inch (lb/inch) width (and N/cm) as an average of at least two samples. The results are shown in Table 2.

The results in Tables 1 and 2 demonstrate that bromo-containing fluoropolymers in combination with peroxide curatives surprisingly adhere especially well to PET.

TABLE 1
Fluoropolymer/PET interfacial adhesion tests after
immersion in boiling water

| | Fluoropolymer/MEK | Boiling water |
|---|---|---|
| Substrate | coating composition | testing |
| PET | KYNAR (8.5 wt %) | Delamination |
| PET | 9:1 KYNAR/PMMA (8.5 wt %) | Delamination |
| PET | 8:2 KYNAR/PMMA (8.5 wt %) | Delamination |
| PET | THV 220 (8.5 wt %) | Delamination |
| PET | E-15742 (10 wt %) | Delamination |
| PET | E-15742 (10 wt %), | No delamination |
| | TAIC (2 wt %), BP (1 wt %) | |
| PET | E-15742 (10 wt %), | No delamination |
| | TAIC (5 wt %), BP (1 wt %) | |
| PET | E-15742 (10 wt %) | No delamination |
| | TMPTMA (1 wt %), BP (1 wt %) | |
| PET | E-15742 (10 wt %) | No delamination |
| | TMPTMA (2 wt %), BP (1 wt %) | |
| PET | E-15742 (10 wt %), | No delamination |
| | TMPTMA (5 wt %), BP (1 wt %) | |

TABLE 2
Fluoropolymer/PET Peel strength

| Sub- | Fluoropolymer/MEK coating | Laminating sheet | Peel strength, |
|---|---|---|---|
| strate | composition | used in pressing | lb/in (N/cm) |
| PET | KYNAR (8.5 wt %) | PVDF | 0.5 (0.9) |
| PET | 9:1 KYNAR/PMMA | PVDF | 0.5 (0.9) |
| | (8.5 wt %) | | |
| PET | 8:2 KYNAR/PMMA | PVDF | 0.5 (0.9) |
| | (8.5 wt %) | | |
| PET | THV 220 (8.5 wt %) | THV 220 | 1.0 (1.8) |
| PET | E-15742 (10 wt %) | THV 220 | 0.6 (1.1) |
| PET | E-15742 (10 wt %), | THV 220 | 6.6 (11.6) |
| | TAIC (5 wt %), | | |
| | BP (1 wt %) | | |
| PET | E-15742 (10 wt %), | THV 220 | 11.0 (19.3) |
| | TMPTMA (1 wt %), | | |
| | BP (1 wt %) | | |
| PET | E-15742 (10 wt %), | THV 220 | 9.7 (17.0) |
| | TMPTMA (2 wt %), | | |
| | BP (1 wt %) | | |
| PET | E-15742 (10 wt %), | THV 220 | 10.0 (17.5) |
| | TMPTMA (5 wt %), | | |
| | BP (1 wt %) | | |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A dental article comprising a nonelastomeric substrate having disposed thereon at least one layer comprising a fluoropolymer, wherein the fluoropolymer is a partially fluorinated polymer, and further wherein:
the fluoropolymer comprises at least 40 wt-% fluorine; and
at least 50% of all fluorine atoms present within the fluoropolymer are within the backbone of the fluoropolymer.

2. The dental article of claim 1 wherein the fluoropolymer is derived from at least one monomer selected from the group consisting of vinylidine fluoride, vinyl fluoride, hexafluoropropylene, tetrafluoroethylene, hexafluoropropylene oxide, and combinations thereof.

3. The dental article of claim 2 wherein the fluoropolymer comprises interpolymerized units derived from vinylidene fluoride.

4. The dental article of claim 3 wherein the fluoropolymer comprises at least 3 wt-% interpolymerized units derived from vinylidene fluoride.

5. The dental article of claim 3 wherein the fluoropolymer comprises interpolymerized units derived from vinylidene fluoride and hexafluoropropylene.

6. The dental article of claim 1 wherein the fluoropolymer is a copolymer.

7. The dental article of claim 1 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, and mixtures thereof.

8. The dental article of claim 1 wherein the fluoropolymer has a molecular weight of at least 10,000 grams/mole.

9. The dental article of claim 1 which is an orthodontic appliance.

10. The dental article of claim 9 wherein the orthodontic appliance is a bracket, buccal tube, archwire, sheath, retainer, arch expander, class II corrector, class III corrector, face bow, or button.

11. The dental article of claim 10 which is an archwire or bracket.

12. The dental article of claim 1 wherein the fluoropolymer-containing layer further comprises a nonfluorinated polymer.

13. The dental article of claim 12 wherein the nonfluorinated polymer is selected from the group consisting of acrylic polymers, urethane polymers, vinyl acetate polymers, and combinations thereof.

14. The dental article of claim 12 wherein the fluoropolymer comprises interpolymerized units derived from vinylidene fluoride.

15. The dental article of claim 1 wherein the nonelastomeric substrate comprises metals, ceramics, or relatively inflexible organic polymeric materials.

16. The dental article of claim 1 wherein at least 75% of the fluorine atoms present in the fluoropolymer are in the backbone of the fluoropolymer.

17. The dental article of claim 16 wherein substantially all the fluorine atoms present are in the backbone of the fluoropolymer.

18. The dental article of claim 1 wherein the fluoropolymer includes less than 5 wt-% silicon atoms.

19. The dental article of claim 18 wherein the fluoropolymer includes less than 3 wt-% silicon atoms.

20. The dental article of claim 19 wherein the fluoropolymer includes substantially no silicon atoms.

21. The dental article of claim 1 wherein the fluoropolymer-containing layer has a peel strength of greater than 0.4 N/cm.

22. A dental article comprising a nonelastomeric substrate having disposed thereon at least one layer comprising a perfluoroelastomer.

23. The dental article of claim 22 wherein the perfluoroelastomer comprises a copolymer of tetrafluoroethylene and perfluoromethyl vinyl ether.

24. The dental article of claim 23 wherein the copolymer of tetrafluoroethylene and perfluoromethyl vinyl ether is prepared using a cure site monomer.

25. The dental article of claim 24 wherein the cure site monomer is 4-cyanoperfluorobutyl vinyl ether.

26. The dental article of claim 22 wherein the perfluoroelastomer has a molecular weight of at least 10,000 grams/mole.

27. The dental article of claim 22 which is an orthodontic appliance.

28. The dental article of claim 27 wherein the orthodontic appliance is a bracket, buccal tube, archwire, sheath, retainer, arch expander, class II corrector, class III corrector, face bow, or button.

29. The dental article of claim 28 which is an archwire or bracket.

30. The dental article of claim 22 wherein the fluoropolymer-containing layer further comprises a nonfluorinated polymer.

31. The dental article of claim 30 wherein the nonfluorinated polymer is selected from the group consisting of acrylic polymers, urethane polymers, vinyl acetate polymers, and combinations thereof.

32. The dental article of claim 22 wherein the nonelastomeric substrate comprises metals, ceramics, or relatively inflexible organic polymeric materials.

33. The dental article of claim 22 wherein the perfluoroelastomer includes less than 5 wt-% silicon atoms.

34. The dental article of claim 33 wherein the perfluoroelastomer includes less than 3 wt-% silicon atoms.

35. The dental article of claim 34 wherein the perfluoroelastomer includes substantially no silicon atoms.

36. A method of reducing adhesion of a substance to a dental article, wherein the method comprises:
providing a dental article comprising a nonelastomeric substrate; and
depositing at least one layer comprising a fluoropolymer to at least a portion of the nonelastomeric substrate; wherein the fluoropolymer is a partially fluorinated polymer, comprises at least 40 wt-% fluorine, and at least 50% of all fluorine atoms present within the fluoropolymer are within the backbone of the fluoropolymer.

37. The method of claim 36 wherein the fluoropolymer is derived from at least one monomer selected from the group consisting of vinylidine fluoride, vinyl fluoride, hexafluoropropylene, tetrafluoroethylene, hexafluoropropylene oxide, and combinations thereof.

38. The method of claim 36 wherein depositing at least one layer comprises applying a coating composition comprising a liquid carrier and the fluoropolymer to the nonelastomeric substrate.

39. The method of claim 38 wherein the liquid carrier is an organic solvent.

40. The method of claim 38 wherein the liquid carrier is water.

41. The method of claim 38 wherein the coating composition is a solution.

42. The method of claim 38 wherein the coating composition comprises 1 wt-% to 20 wt-% of the fluoropolymer.

43. The method of claim 36 wherein depositing at least one layer comprises dipping the nonelastomeric substrate in a coating composition comprising the fluoropolymer.

44. The method of claim 36 further comprising thermally curing the applied coating composition.

45. The method of claim 36 wherein at least 75% of the fluorine atoms present in the fluoropolymer are in the backbone of the fluoropolymer.

46. The method of claim 45 wherein substantially all of the fluorine atoms present in the fluoropolymer are present in the backbone of the fluoropolymer.

47. The method of claim 36 wherein the fluoropolymer includes less than 5 wt-% silicon atoms.

48. The method of claim 36 wherein the fluoropolymer comprises interpolymerized units derived from vinylidene fluoride, vinyl fluoride, hexafluoropropylene, tetrafluoroethylene, hexafluoropropylene oxide, and combinations thereof.

49. The method of claim 48 wherein the fluoropolymer is selected from the group consisting of tetrafluoroethylene/hexafluoropropylene/vinylidene fluoride terpolymer, polyvinylidene fluoride, vinylidene fluoride/hexafluoropropylene copolymer, vinylidene fluoride/tetrafluoroethylene copolymer, and mixtures thereof.

50. The method of claim 36 wherein the dental appliance is an orthodontic appliance.

51. The method of claim 50 wherein the orthodontic appliance is a bracket, buccal tube, archwire, sheath, retainer, arch expander, class II corrector, class III corrector, face bow, or button.

52. A method of reducing adhesion of a substance to a dental article, wherein the method comprises:
providing a dental article comprising a nonelastomeric substrate; and
depositing at least one layer comprising a perfluoroelastomer.

53. The method of claim 52 wherein the perfluoroelastomer comprises a copolymer of tetrafluoroethylene and perfluoromethyl vinyl ether.

54. The method of claim 53 wherein the perfluoroelastomer is prepared using a cure site monomer.

55. The method of claim 54 wherein the cure site monomer is 4-cyanoperfluorobutyl vinyl ether.

56. The method of claim 52 wherein depositing at least one layer comprises applying a coating composition comprising a liquid carrier and the perfluoroelastomer to the nonelastomeric substrate.

57. The method of claim 56 wherein the liquid carrier is an organic solvent.

58. The method of claim 56 wherein the liquid carrier is water.

59. The method of claim 56 wherein the coating composition is a solution.

60. The method of claim 56 wherein the coating composition comprises 1 wt-% to 20 wt-% of the perfluoroelastomer.

61. The method of claim 52 wherein depositing at least one layer comprises dipping the nonelastomeric substrate in a coating composition comprising the perfluoroelastomer.

62. The method of claim 52 further comprising thermally curing the applied coating composition.

63. The method of claim 52 wherein the perfluoroelastomer includes less than 5 wt-% silicon atoms.

64. The method of claim 52 wherein the dental appliance is an orthodontic appliance.

65. The method of claim 64 wherein the orthodontic appliance is a bracket, buccal tube, archwire, sheath, retainer, arch expander, class II corrector, class III corrector, face bow, or button.

66. A nonelastomeric substrate comprising an organic polymeric material having disposed thereon at least one layer comprising a fluoropolymer, wherein the fluoropolymer is prepared from a halogen-containing fluoropolymer and a peroxide curing system comprising an organic peroxide initiator and a multifunctional aliphatic unsaturated compound.
